(19) United States
(12) Patent Application Publication
(10) Pub. No.: US 2025/0288147 A1
(43) Pub. Date: Sep. 18, 2025

(54) COFFEE MACHINE WITH SIMPLIFIED HYDRAULIC CIRCUIT DISTRIBUTION

(71) Applicant: DE' LONGHI APPLIANCES S.r.l., Treviso (IT)

(72) Inventors: Paolo EVANGELISTI, Treviso (IT); Nicola PIOVAN, Treviso (IT); Alberto ACCIARI, Treviso (IT); Davide BONOTTO, Treviso (IT)

(73) Assignee: DE' LONGHI APPLIANCES S.r.l., Treviso (IT)

(21) Appl. No.: 18/861,419

(22) PCT Filed: May 3, 2023
(86) PCT No.: PCT/EP2023/061604

§ 371 Date: Oct. 29, 2024

(30) Foreign Application Priority Data
May 6, 2022 (IT) 102022000009419

(51) Int. Cl. A47J 31/46; A47J 31/52

(52) U.S. Cl. CPC A47J 31/461; A47J 31/469; A47J 31/52

(57) ABSTRACT

A coffee machine comprises a hydraulic circuit provided with hoses and a distributor comprising one or more pinch valves, a shaft with one or more cams for controlling the switching of the pinch valves and an actuator of said shaft with cams, wherein each pinch valve has at least one movable choke, configured to choke a section of a hose of the hydraulic circuit, and a drive element for driving the movable choke.

### CROSS-REFERENCE TO RELATED APPLICATIONS

This is a U.S. National Phase Application under 35 U.S.C. 371 of International Patent Application No. PCT/EP2023/061604, filed May 3, 2023, which claims benefit of priority to Italian Patent Application No. 102022000009419, filed May 6, 2022. The entire contents of these applications are hereby incorporated by reference.

### FIELD OF THE INVENTION

The present invention relates to a coffee machine with simplified hydraulic circuit distribution. The various types of coffee machines currently on the market comprise a hydraulic circuit that includes a water feed pump, a boiler and a coffee brewer in cascade.

### BACKGROUND

In many types of known coffee machines, the hydraulic circuit generally also includes a steam production line and a drain line to which the delivery of the feed pump and the coffee brewer are connected.

The functions that the user requests are often very similar regardless of the specific type of coffee machine.

In fact, such functions include triggering the feed pump, dispensing the beverage, emptying the hydraulic circuit, discharging the pressure in the brewer, dispensing steam, etc.

In order to execute all the functions, the hydraulic circuit is provided with a distribution system that is generally quite complex and difficult to manage.

The distribution system, depending on the solutions adopted, can include manual valves, automatic valves with electric actuator, automatic valves with hydraulic actuator.

In some cases the distribution systems of the hydraulic circuit includes various types of selectors, including selectors with direct-actuation pistons, selectors with indirect-actuation pistons with fluid separation, ceramic or plastic discs.

These distribution systems are already known, for example, from WO2019/121270, DE19545112, WO2017/063784, EP1916459.

The current distribution systems have the problem of having been developed for specific applications and not allowing customizations, particularly in relation to the number of paths, the sequence of the actuations and the combination of the actuations.

### SUMMARY

The technical task of the present invention is, therefore, to realize a coffee machine which obviates the above-described technical drawbacks of the prior art.

Within the context of this technical task, an object of the invention is to realize a coffee machine capable of operating while limiting and/or simplifying the manual operations required of the final user.

Another object of the invention is to realize a coffee machine capable of expanding the functions of the distribution system of the hydraulic circuit at will and in a personalized manner.

Another object of the invention is to realize a coffee machine with a hydraulic circuit having an always extremely efficient and reliable distribution system regardless of the complexity and number of functions attributed thereto.

Another object of the invention is to realize a coffee machine with a hydraulic circuit having an economic and constructively simple distribution system.

The technical task, as well as these and other objects, according to the present invention are achieved by realizing a coffee machine characterized in that it comprises a hydraulic circuit provided with hoses and a distributor comprising one or more pinch valves, a shaft with one or more cams for controlling the switching of the pinch valves and an actuator of said shaft with cams, where each pinch valve has at least one movable choke, configured to choke a section of a hose of the hydraulic circuit, and a drive element for driving the movable choke.

In an embodiment of the invention each cam of said shaft with cams interacts with a corresponding drive element of a movable choke.

In an embodiment of the invention, said actuator is electric.

In an embodiment of the invention, said distributor has an angular position sensor for said shaft with cams.

In an embodiment of the invention, each pinch valve is formed by a modular valve module.

In an embodiment of the invention, said modular valve module is single-stage.

In an embodiment of the invention, said modular valve is multi-stage.

In an embodiment of the invention, said shaft with cams is formed by one or more modular shaft modules.

In an embodiment of the invention, said one or more modular shaft modules comprises at least one single-stage shaft module.

In an embodiment of the invention, said one or more modular shaft modules comprises at least one multi-stage shaft module.

In an embodiment of the invention, said one or more modular shaft modules has a mutual connection means for quick coupling.

In an embodiment of the invention said hydraulic circuit comprises a feed pump, a boiler, a brewer, a first hose connected to an outlet of the brewer and to an external coffee dispenser and having a back pressure valve, a second hose of bypass of said back pressure valve, where said first hose is provided with a first pinch valve downstream of said second hose and said second hose is provided with a second pinch valve.

In an embodiment of the invention said hydraulic circuit comprises a third hose connecting said first hose and second hose to a drain, where said third hose is provided with a third pinch valve.

In an embodiment of the invention said hydraulic circuit comprises a fourth hose connecting the delivery of said feed pump to said drain, where said fourth hose is provided with a fourth pinch valve.

The invention advantageously allows to simplify the hydraulic circuit by employing a distribution system with pinch valves capable of completely choking a section of a hose to the point of interrupting the passage of fluid.

The pinch valves have the advantage of eliminating the need for narrowing the tubes, where turbulence and sediment could be deposited and, by not operating in contact with the fluid flowing in the tubes, do not pose problems of hygiene and compatibility with food regulations.

Thanks to its modularity, the distribution system is easily customizable and adaptable from time to time to the specific application.

### BRIEF DESCRIPTION OF THE DRAWINGS

Further features and advantages of the invention will become more apparent from the description of a non-exclusive embodiment thereof, of the coffee machine according to the invention, which is illustrated by way of approximate and non-limiting example in the drawings, in which:

FIG. 1 schematically shows a hydraulic circuit of a coffee machine according to a possible embodiment;

FIG. 2 shows in exploded form a single-stage modular pinch valve that can be employed in the distributor of the hydraulic circuit of a coffee machine according to a possible embodiment;

FIG. 3 shows a perspective view of the assembled single-stage modular pinch valve of FIG. 2;

FIG. 4 shows a perspective view of the single-stage modular pinch valve of FIG. 3 applied to a hose of the hydraulic circuit of a coffee machine according to a possible embodiment;

FIG. 5 shows a side elevation view of the assembled single-stage modular pinch valve of FIG. 2;

FIG. 6 shows a view of the modular single-stage pinch valve sectioned along the line A-A of FIG. 5, in the choked state of the section of the hose;

FIG. 7 shows a view of the single-stage modular pinch valve sectioned along the line A-A of FIG. 5, in the release state of the section of the hose;

FIG. 8 shows modular single-stage valves that can be part of a distributor of a hydraulic circuit of a coffee machine according to a possible embodiment;

FIG. 9 shows a single-stage modular valve of a distributor of a hydraulic circuit of a coffee machine according to a possible embodiment;

FIG. 9a shows the multi-stage modular valve of FIG. 9 without a cover and with the actuator disconnected;

FIG. 10 shows two modular single-stage valves that can be part of a distributor of a hydraulic circuit of a coffee machine according to a possible embodiment;

FIG. 11 shows a single-stage modular shaft with cams of a distributor of a hydraulic circuit of a coffee machine according to a possible embodiment;

FIG. 12 shows a single-stage modular shaft with cams of a distributor of a hydraulic circuit of a coffee machine according to a possible embodiment; and

FIGS. 13a-13e show various shapes of the cams adoptable for every possible drive angle of the shaft with cams of a distributor of a hydraulic circuit of a coffee machine according to a possible embodiment.

### DETAILED DESCRIPTION

With reference to the figures cited, the hydraulic circuit of a coffee machine is shown which in a known manner in the minimum configuration comprises a feed pump 1, a boiler 2 and an brewer 3 connected in cascade.

The feed pump 1 is connected to a water source 4 which can directly be the water mains or a tank installed in the coffee machine.

A flow meter 5 can be positioned between the water source 4 and the feed pump 1.

For the reasons that will be more evident below, the hydraulic circuit of the coffee machine has hoses.

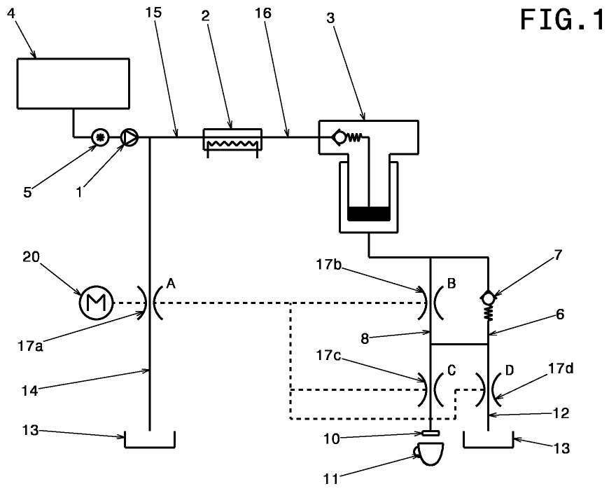

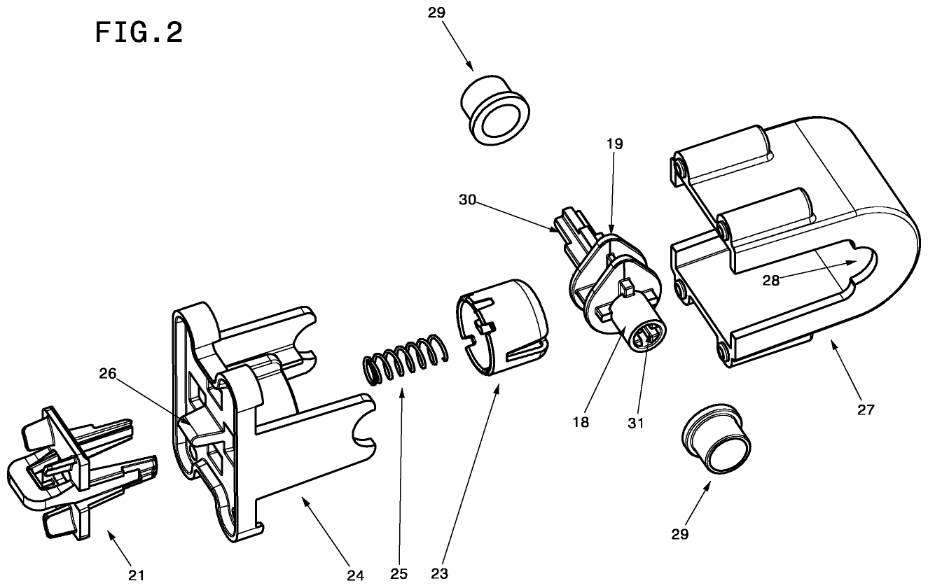

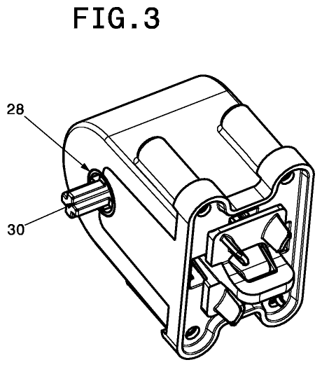

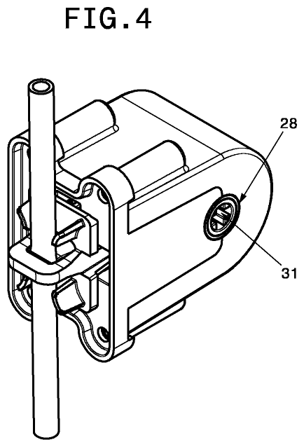

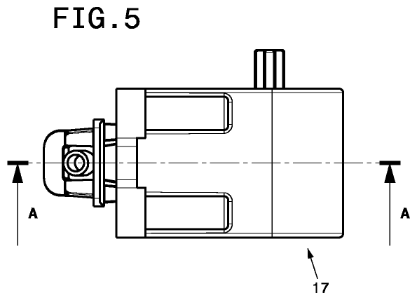

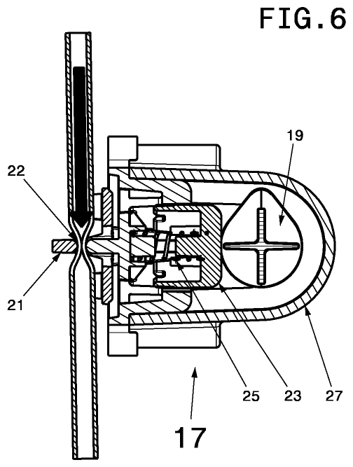

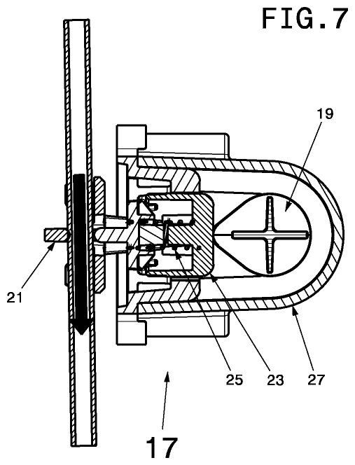

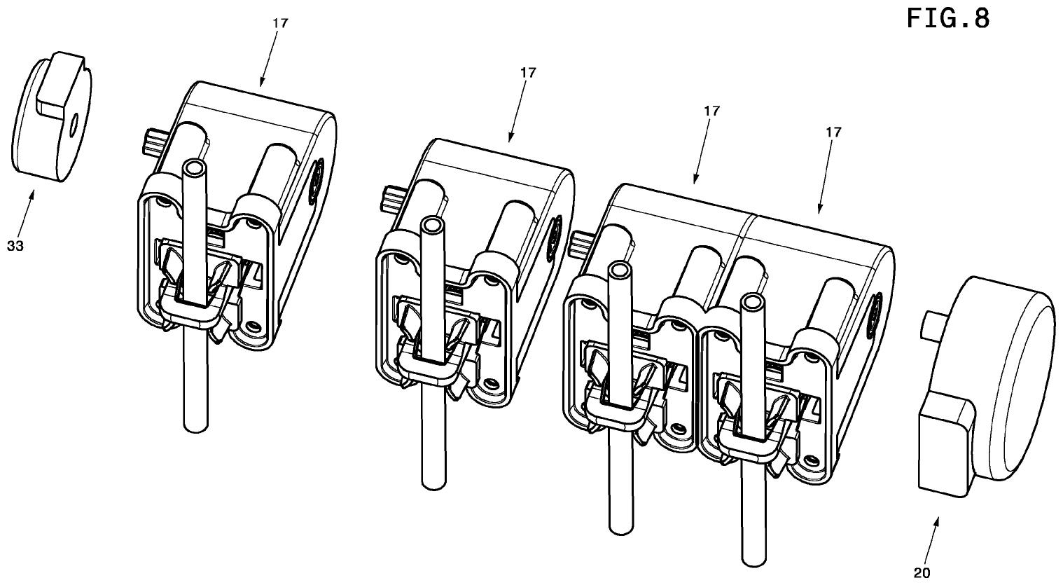

In the solution illustrated in FIG. 1 merely by way of example, the hydraulic circuit comprises a first hose 6 connected to an outlet of the brewer 3 and to an external coffee dispenser 10 and having a back pressure valve 7, and a second hose 8 of bypass of the back pressure valve 7 which branches from the first hose 6 upstream of the compression valve 7 and rejoins the first hose 6 downstream of the back pressure valve 7.

The external dispenser 10 of the coffee machine can dispense coffee directly into a container 11, particularly a cup.

The hydraulic circuit further comprises a third hose 12 connecting the first hose 6 and the second hose 8 to a drain 13.

The hydraulic circuit comprises a fourth hose 14 connecting the delivery of the feed pump 1 to the drain 13.

The hydraulic circuit further comprises other hoses 15, 16 connecting the feed pump 1 to the boiler 2 and respectively the boiler 2 to the brewer 3, which in the illustrated case can also be flexible.

The hydraulic circuit can obviously be more complex than that illustrated here and comprise for example a steam dispensing hose connected to the boiler 2 or to another boiler not illustrated.

Also the steam dispensing hose, if provided, always for reasons that will be clearer below, can be flexible.

Advantageously, the hydraulic circuit of the coffee machine includes a distributor comprising one or more pinch valves 17, a shaft 18 with one or more cams 19 for controlling the switching of the pinch valves 17 and an actuator 20 of the shaft 18 with cams 19.

Each pinch valve 17 has at least one movable choke 21, configured to choke a section 22 of a hose of the hydraulic circuit, and a drive element 23 for driving the movable choke 21.

Each cam 19 of the shaft 18 may interact with a corresponding drive element 23 of a movable choke 21.

Advantageously, each pinch valve 17 is formed by a modular valve module. Advantageously, moreover, each valve module can be single-stage or multi-stage.

A single-stage valve module comprises a single choke 21 operating on a section of a single hose, while a multi-stage valve module comprises multiple chokes 21 each operating on a section of a different hose.

The number and type of valve modules to be composed can be freely chosen depending on the functions for which the distributor is responsible.

Therefore, there are innumerable combinations of single-stage and/or multi-stage valve modules.

In the simplest limit case, a single pinch valve 17 formed by a single single-stage valve module can be included, but clearly the invention is all the more advantageous the more numerous the functions of the hydraulic circuit of the coffee machine.

For example, the distributor can include a single pinch valve 17 formed by a multi-stage valve module, or a composition of multiple pinch valves 17 each of which can be formed by a single-stage or multi-stage valve module.

Similarly, the shaft 18 with cams 19 is also formed by one or more modular shaft modules. A modular shaft module can in turn be single-stage or multi-stage.

A single-stage shaft module has a single cam 19 intended to operate on a single drive element 23.

A multi-stage shaft module instead has multiple cams 19 each intended to operate on a different drive element 23.

The modular shaft modules have a mutual connection means for quick coupling.

In particular, the mutual connection means for quick coupling can comprise grooved pins 30 that can be engaged in grooved seats 31 of conjugate shape.

The number and type of shaft modules can be freely chosen depending on the functions for which the distributor is responsible.

Therefore, there are also innumerable combinations of single-stage and/or multi-stage shaft modules.

Of course the choice of shaft modules must be consistent with the choice of valve modules so that each drive element 23 is assigned a corresponding cam 19.

Obviously, in the case of multiple valve modules, they must be assembled according to the axis of the shaft with cams.

The construction of a single-stage valve module includes a fixed body 24 which supports and guides the sliding in translation of the choke 21.

The choke 21 and the drive element 23 are mutually coupled so as to translate integrally by action and in contrast to a return spring 25.

With a protrusion 26 of the fixed body 24, the movable choke 21 delimits an area of variable size where a section of a hose of the hydraulic circuit is trapped.

A cover 27 is mounted on the fixed body 24 that delimits, with two opposite side walls of the fixed body 24, special aligned through holes 28 that house support bushes 29 rotating on itself of the shaft 18 with cams 19.

The cam 19 positioned inside the cover 27 moves the drive element 23 due to the angular rotation of the shaft 18 on itself.

The cam 19 operates in a first angular position releasing the section of the hose 20 and a second angular position choking the section of the hose.

In the movement towards the first angular position the cam 19, acting on the drive element 23 in contrast to the spring 25, causes the movement of the choke 21 away from the protrusion 26.

In contrast, in the movement towards the second angular position of the cam 19, the spring 25 acts on the drive element 23 causing the movement of the choke 21 towards the protrusion 26.

The individual stages of a multi-stage valve module are as described above.

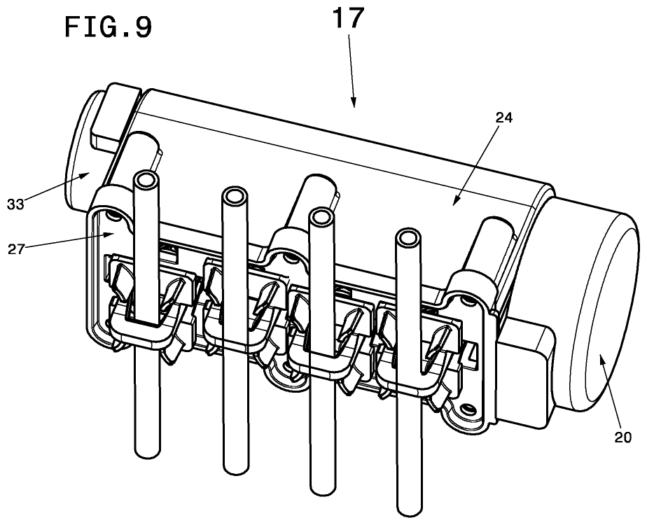

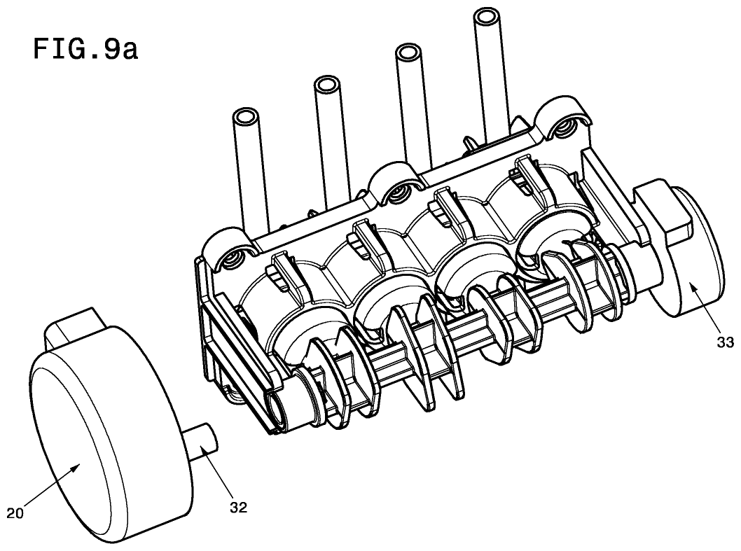

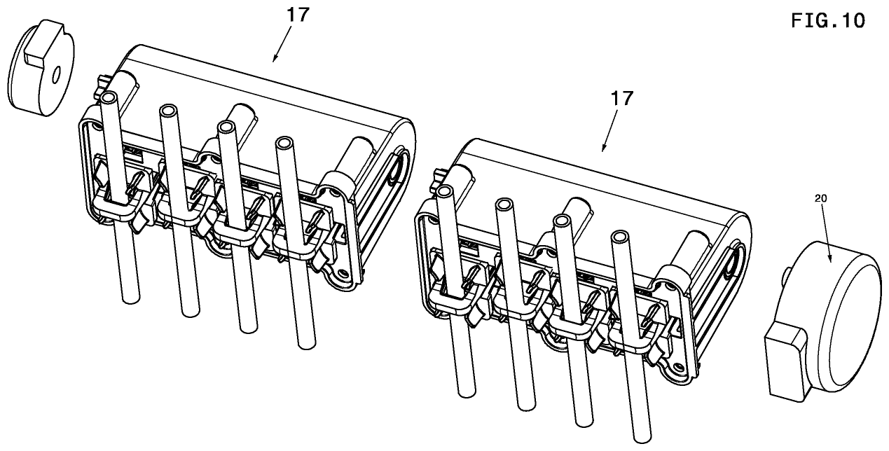

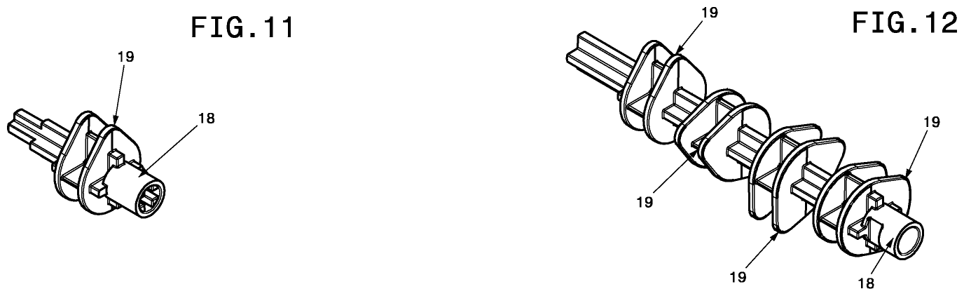

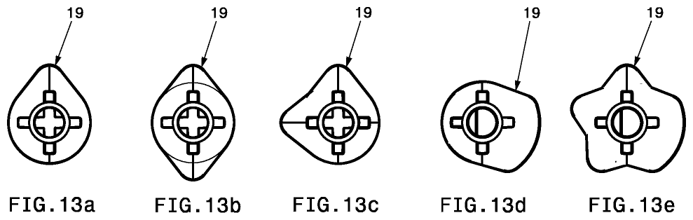

The stages of a multi-stage valve module may have the fixed body 24 and the cover 27 in common, as shown for example in FIG. 9.

If multiple valve modules are included, the fixed bodies 24 of the valve modules are arranged side by side so as to match the passage holes 28 of the shaft 18 with cams 19.

The hydraulic circuit of the exemplified coffee machine comprises a first pinch valve 17a operative on the first hose 6 downstream of the junction point with the second hose 8, a second pinch valve 17b operative on the second hose 8, a third pinch valve 17c operative on the third hose 12 and a fourth pinch valve 17d operative on the fourth hose 14.

In this case the distributor of the hydraulic circuit must control four stages, and therefore can include a four-stage modular valve, four combined single-stage modular valves, two combined two-stage modular valves, one single-stage modular valve and one combined three-stage modular valve, etc.

In a consistent manner, the modularity of the shaft with cams is chosen for the control of the four valve stages.

The actuator 20 can be electric, and in particular can be an electric motor configured to drag the shaft 18 with cams 19 in rotations of predetermined angles.

Advantageously, a quick coupling connection means is provided between the shaft 32 of the electric motor and the shaft 18 with cams 19, which may be of the same type as those included for the connection between the shaft modules with cams.

Obviously the actuator 20 can be of another type, for example mechanical or hydraulic. The distributor also advantageously has an angular position sensor 33 of the shaft 18 with cams 19.

The position sensor 33 can be for example of the encoder or microswitch type.

The electronic controller of the coffee machine can thus perform a precise control of the angular position of the shaft 18 with cams 19.

This is fundamental since the rotation of the shaft 18 with cams 19 determines the law of motion of the drive elements 3 and consequently of the chokes 21.

In this regard, the electronic controller of the coffee machine is configured to execute functions selectable by a user, and attributes a different angular position of the shaft 18 with cams 19 to each function.

This is clarified with reference to the hydraulic circuit of the coffee machine depicted in FIG. 1, where a typical sequence of functions is as follows.

The first function corresponds to the coffee machine at rest.

The controller pairs a first rotation angle of the shaft 18 with cams 19 to this function.

At this first rotation angle of the shaft 18, each of the four cams 19 assumes a position to which the closure of the corresponding pinch valve 17a, 17b, 17c, 17d corresponds.

The second function includes triggering the feed pump 1.

The controller pairs a second rotation angle of the shaft 18 with cams 19 to this function, which is different from the first rotation angle.

At this second rotation angle of the shaft 18, the first, the second and the third cam 19 assume a position to which the closure of the corresponding first, second and third pinch valve 17a, 17b, 17c corresponds, while the fourth cam 19 assumes a position to which the opening of the corresponding fourth pinch valve 17d corresponds.

The water drawn from the source 4 is sent from the feed pump 1 directly to the fourth hose 14 and then to the drain 13.

The third function includes the dispensing of drip coffee.

The controller pairs a third rotation angle of the shaft 18 with cams 19 to this function, which is different from the first and from the second rotation angle.

At this third rotation angle of the shaft 18, the first and the second cam 19 assume a position to which the opening of the corresponding first and second pinch valve 17a, 17b, corresponds, while the third and the fourth cam 19 assumes a position to which the closing of the corresponding third and fourth pinch valve 17c, 17d corresponds.

The water drawn from the source 4 is sent from the feed pump 1 to the brewer 3 and therefrom to the external dispenser 10 through the second hose 8 which by passes the overpressure valve 7.

The fourth function includes the dispensing of espresso coffee, and can be selected as an alternative to the third function.

The controller pairs a fourth rotation angle of the shaft 18 with cams 19 to this function, which is different from the first, second and third rotation angle.

At this fourth rotation angle of the shaft 18, the first cam 19 assumes a position to which the opening of the corresponding first pinch valve 17a corresponds, while the second, third and the fourth cam 19 assume a position to which the closing of the corresponding second, third and fourth pinch valve 17b, 17c 17d corresponds.

The water drawn from the source 4 is sent from the feed pump 1 to the brewer 3 and therefrom to the external dispenser 10 through the section of the first hose 6 where the overpressure valve 7 is included.

The fifth function includes drying the used coffee pod.

The controller pairs a fifth rotation angle of the shaft 18 with cams 19 to this function, which is different from the first, second, third and fourth rotation angle.

At this fifth rotation angle of the shaft 18, the second and the third cam 19 assume a position to which the opening of the corresponding second and third pinch valve 17b, 17c corresponds, while the first and the fourth cam 19 assume a position to which the closing of the corresponding first and fourth pinch valve 17a, 17d corresponds.

The water released from the squeezing of the used coffee pod is conveyed to the hose 12 and from here to the drain 13.

If the machine were to include a more sophisticated hydraulic circuit capable of carrying out an additional function, for example a sixth steam dispensing function, it would be sufficient to add a valve stage and a stage shaft with cams: to this sixth function the controller would pair a sixth rotation angle of the shaft 18 with cams 19, different from the first, second, third, fourth and fifth rotation angle. And so on for other additional functions.

The coffee machine as conceived herein is susceptible to many modifications and variations, all falling within the scope of the inventive concept; further, all the details are replaceable by technically equivalent elements.

The materials used, as well as the dimensions, may in practice be any whatsoever according to needs and the state of the art.

1. A coffee machine comprising: a hydraulic circuit provided with hoses and a distributor comprising one or more pinch valves, a shaft with one or more cams for controlling the switching of the pinch valves and an actuator of said shaft with cams, wherein each pinch valve has at least one movable choke, configured to choke a section of a hose of the hydraulic circuit, and a drive element for driving the movable choke.

2. The coffee machine according to claim 1, wherein each cam of said shaft with cams interacts with a corresponding drive element for driving a movable choke.

3. The coffee machine according to claim 1, wherein said actuator is electric.

4. The coffee machine according to claim 1, wherein said distributor has an angular position sensor for said shaft with cams.

5. The coffee machine according to claim 1, characterized in that each pinch valve is formed by a modular valve module.

6. The coffee machine according to claim 5, wherein said modular valve module is single-stage.

7. The coffee machine according to claim 5, wherein said modular valve module is multi-stage.

8. The coffee machine according to claim 1, wherein said shaft with cams is formed by one or more modular shaft modules.

9. The coffee machine according to claim 8, wherein said one or more modular shaft modules have a mutual connection means for quick coupling.

10. The coffee machine according to claim 2, wherein said modular shaft modules comprise at least one single-stage shaft module.

11. The coffee machine according to claim 8, wherein said modular shaft modules comprise at least one multi-stage shaft module.

12. The coffee machine according to claim 1, wherein said hydraulic circuit comprises a feed pump, a boiler, a brewer, a first hose connected to an outlet of the brewer and to an external coffee dispenser and having a back pressure valve, a second hose of bypass of said back pressure valve, wherein said first hose is provided with a first pinch valve downstream of said second hose and said second hose is provided with a second pinch valve.

13. The coffee machine according to claim 12, wherein said hydraulic circuit comprises a third hose connecting said first hose and second hose to a drain, wherein said third hose is provided with a third pinch valve.

14. The coffee machine according to claim 12, wherein said hydraulic circuit comprises a fourth hose connecting the delivery of said feed pump to said drain, wherein said fourth hose is provided with a fourth pinch valve.

15. The coffee machine according to claim 1, further comprising an electronic controller configured for the execution of functions selectable by a user, said electronic controller attributing to each function a different angular position of said shaft with cams.
